(19) United States
(12) Patent Application Publication
(10) Pub. No.: US 2009/0307288 A1
(43) Pub. Date: Dec. 10, 2009

(54) BACKUP DEVICE

(75) Inventors: Shuichi Kitaguchi, Kawasaki (JP); Takeshi Yamazaki, Kawasaki (JP); Mako Kawaguchi, Kawasaki (JP); Tsuyoshi Matsumoto, Kawasaki (JP); Yuusuke Shimada, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/539,983

(22) Filed: Aug. 12, 2009

Related U.S. Application Data
(63) Continuation of application No. PCT/JP2007/000146, filed on Feb. 28, 2007.

(51) Int. Cl. G06F 12/00; G06F 17/30; G06F 12/16

(52) U.S. Cl. 707/204; 709/223; 707/E17.01; 707/E17.044; 711/E12.103

(57) ABSTRACT

The backup server in the backup site receives messages multicast from business servers in the primary site, extracts the business data, and stores it in backup databases for each business server. Upon this storing of business data, the sequence numbers in the messages are added to the business data to be stored in the backup databases. Detection of loss in sequence numbers allows the detection of which piece of the business data is lost. The backup server does not request a business server in the primary site to retransmit data even when business data is partially lost, but instead directly requests the database server in the primary site to transmit the lost business data.

### CROSS-REFERENCE TO RELATED APPLICATION

This application is a continuation application of International PCT Application No. PCT/JP2007/000146, filed on Feb. 28, 2007, the entire contents of which are incorporated herein by reference.

### FIELD

The embodiments discussed herein are related to a backup device for storing business messages in a backup site for backup purposes.

### BACKGROUND

Generally, there are two methods that can be used for transferring business messages to a backup site (having a database for backup) ; one is a method in which business messages are transferred independently from business communications, and the other is a method in which the database storing business messages is mirrored. In the method in which business messages are transferred independently, the transmitter side transmits business messages both to a primary site (having a server for conducting business and a database server for storing business messages) and a backup site, which imposes a lot of load on the transmitter side because it has to transmit a message twice. Also, in an environment using reliable multicast technology (see RFC3208: a technology by which data is multicast, and when the receiver side fails to receive it normally, the data is retransmitted) in order to secure the arrival of data while reducing the load on the transmitter side, each detection of loss in a message in a backup site requires the primary site to retransmit the lost message. Consequently, the occurrence of delay in the transfer of messages to the backup site influences real-time transfer processes in the primary site, which is problematic.

In the method in which a database is mirrored, data is periodically transferred from the primary site to the backup site using a function of a database. In this method, the load of transferring is imposed on the database server, and also there is a time lag between the time when the database in the primary site receives a message and when it transfers the message to the backup site because the transmission of messages is performed at prescribed time intervals, which is problematic.

Patent Document 1 discloses a data transfer system that performs high-speed data transfer services with high reliability and small overhead.

In the conventional techniques, real-time transfer processes in the primary site are influenced by the loads imposed on the business server in the primary site or by the load on the database server and the time lag before transferring messages to the backup site.

Patent Documents 2 through 4 disclose a method in which a business server generates messages to be transferred to the backup server, and the messages are transmitted (periodically).

Patent Document 5 discloses a method in which a function in a storage device is used instead of using a function in a server in order to perform a message transfer process for back up purposes.

However, none of the techniques disclosed in Patent Documents 2 through 5 above satisfy the following conditions.
influence of backup process on routine processes can be reduced to almost zero
the number of messages to communicate can be reduced as much as possible because communication between a business server and a database server is one of main processes performed for business, and it should be completed in a very short time to avoid the occurrence of unnecessary load
because a backup server is located in a remote place, the transmission of messages to a backup server by using generally practiced reliable multicast technology (such as the multicast protocol described in RFC3208) causes a great delay, requires much time to confirm the arrival, and imposes a greater load on the business server for the retransmission, and the like
messages can be transferred to a backup server using functions in a database server or a storage device; however, a single network is used both for the transfer of messages to the backup site and the transfer of messages for business communications, which influences the business communications
messages need to be backed up in as close to real time as possible
when the primary site is damaged by disaster, the backup site needs to be moved within a short period of time
loss in messages is desirably limited to a minimum in case of disaster

### Patent Document 1:

Japanese Laid-open Patent Publication No. 2004-080070

### Patent Document 2:

Japanese Patent No. 02509460

### Patent Document 3:

Japanese Laid-open Patent Publication No. 7-244597

### Patent Document 4:

Japanese Laid-open Patent Publication No. 6-290125

### Patent Document 5:

Japanese Laid-open Patent Publication No. 2003-050720

### SUMMARY

A backup device according to the invention is a backup device in a system including a business server that generates a business message and transmits the business message to a database as a main storage means for storing business data in the business message and to a backup database for storing the business data for backing up the business data, said device comprising: a business data reception/extraction unit for receiving the transmitted message and extracting the business data included in the message; a business data storage unit for storing, in the backup database, the business data for each business server as a transmission source; a lost business data detection unit for detecting whether or not the business data stored in the backup database is partially lost; and a lost business data transmission requesting unit that does not request the business server, but requests the database to transmit lost business data when the business data is partially lost, wherein the business data is transmitted from the business server using multicast transmission.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed

### BRIEF DESCRIPTION OF DRAWINGS

FIG. 1 illustrates a functional configuration of a business server according to an embodiment of the invention;

FIG. 2 illustrates a functional configuration of a backup server provided in the backup site;

FIG. 3 illustrates a functional configuration of a database (DB) server provided in the primary site;

FIG. 4A illustrates a format of a business message (first);

FIG. 4B illustrates a format of a business message (first);

FIG. 4C illustrates a format of a business message (first);

FIG. 4D illustrates a format of a business message (first);

FIG. 5A illustrates a format of a business message (second);

FIG. 5B illustrates a format of a business message (second);

FIG. 5C illustrates a format of a business message (second);

FIG. 6A illustrates a format of a business message (third);

FIG. 6B illustrates a format of a business message (third);

FIG. 6C illustrates a format of a business message (third);

FIG. 6D illustrates a format of a business message (third);

FIG. 7A illustrates a format of a business message (fourth);

FIG. 7B illustrates a format of a business message (fourth);

FIG. 7C illustrates a format of a business message (fourth);

FIG. 8 illustrates a process flow in the business server used when it is transmitting a business message;

FIG. 9 illustrates a process flowchart for a business message reception process performed by the backup server;

FIG. 10 illustrates a process flowchart for a DB data complement process performed by the backup server;

FIG. 11 illustrates a process flowchart for a business message reception process performed by the DB server; and

FIG. 12 illustrates a process flowchart for a DB request response process performed by the DB server.

### DESCRIPTION OF EMBODIMENTS

In an embodiment of the invention, multicast transmission is performed so that a business message is transferred to the backup site without influencing a real-time transfer process in the primary site. Also, when business data is stored by a database in a real-time transfer process in the primary site, a sequence number added to each piece of business data is also stored. The arrival of a business message is guaranteed because lacking sequence numbers in the backup site are detected and an inquiry is made to the database of the primary site for the minimum necessary data, specifically, the message with the lacking sequence number, in order to obtain the lost messages. Thereby, the arrival of business messages can be guaranteed while minimizing an increase in the load on the business server in the primary site.

As described above, a business message can be transferred from the primary site to the backup site in real time while suppressing, to a minimum (almost zero), the load imposed on the business server in the primary site so as to guarantee the arrival of the business message.

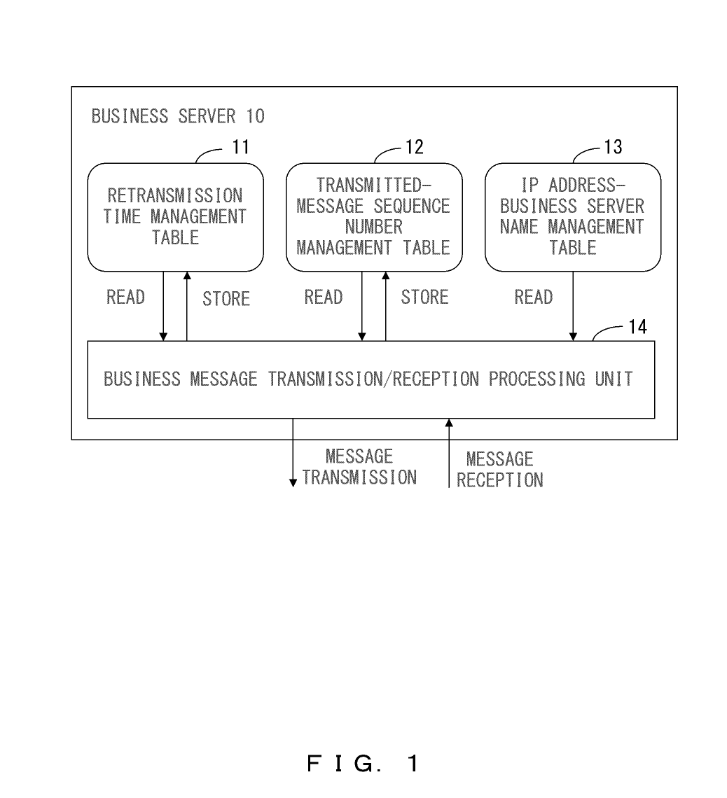

FIG. 1 illustrates a functional configuration of a business server according to an embodiment of the invention.

A business message transmission/reception processing unit 14 in a business server 10 is a communications interface for transmitting messages to a database server in the primary site and to the backup site, and for receiving messages transmitted from those sites. When a message is to be transmitted to the database server in the primary site and the backup site, the message is multicast. In a multicast transmission, when the transmitter side has transmitted a single piece of data whose IP address specifies the multicast, network devices such as routers make copies of the data to transmit them to a plurality of destinations automatically, and thus multicast transmission imposes less load on the server than when a business server in the primary site generates a plurality of pieces of data to transmit them to respective destinations. A retransmission time management table 11 is used for setting the maximum number of times a message can be retransmitted to database servers in the primary site. Even when a message does not arrive at a database server in the primary site, making the database server request retransmission, the message is not retransmitted a greater number of times than the maximum number set for that message in the retransmission time management table 11. A transmitted-message sequence number management table 12 stores the sequence numbers of messages already transmitted to database servers in the primary site and to the backup site from the business server 10. This table makes it possible to manage the numbers of messages to which the transmission of messages has been completed. An IP address-business server name management table 13 stores IP addresses of message transmission sources and business server names in an associated state.

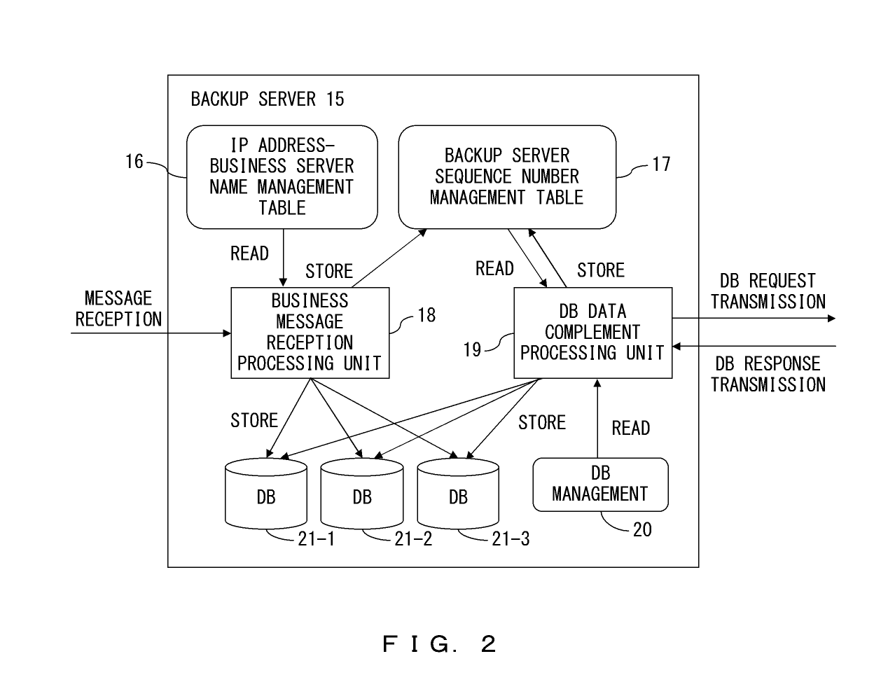

FIG. 2 illustrates a functional configuration of a backup server used in the backup site.

In a backup server 15, a business message reception processing unit 18 receives messages. The correspondence, registered in an IP address-business server name management table 16, between the IP addresses of message transmitters and the business server names of the business servers that transmitted those messages allows the business message reception processing unit 18 to determine the business server that transmitted each message. Also, the business message reception processing unit 18 stores, in a backup server sequence number management table 17, the sequence numbers set in the messages in order to match messages with the message numbers that have been received properly. The business message reception processing unit 18 stores the received messages in backup databases 21-1 through 21-3. A DB data complement processing unit 19 refers to the backup server sequence number management table 17 to determine the messages that have not been received, and requests the database server in the primary site to transmit those messages. This means that the business server in the primary site is not requested to retransmit the message having a portion of its business data lost, which reduces the load on the business server. The DB data complement processing unit 19 can determine the database server in the primary site corresponding to the business server to which the request for transmitting a message is to be made. When the DB data complement processing unit 19 receives a response indicating the transmission, from the database, of a message that is partially lost, it registers the sequence number of the transmitted message in the backup server sequence number management table 17. Also, the DB data complement processing unit 19 stores, in the backup databases 21-1 through 21-3 in accordance with a DB management table 20, the messages received by the business message reception processing unit 18, and stores, in the backup databases 21-1 through 21-3, the sequence numbers of the stored messages in a state in which the sequence numbers are associated with the received messages.

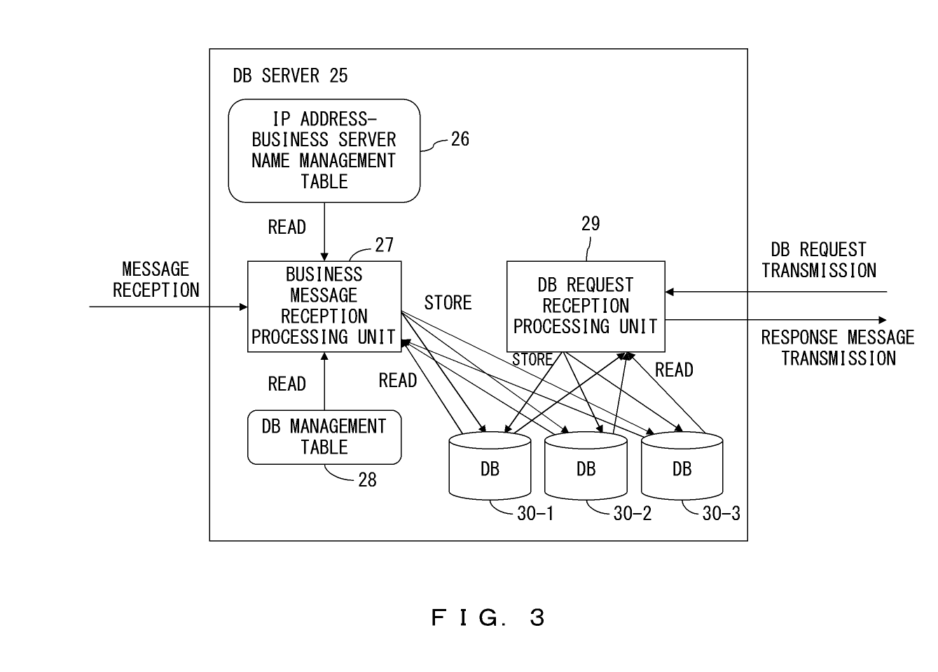

FIG. 3 illustrates a functional configuration of a database (DB) server provided in the primary site.

In a DB server 25, a business message reception processing unit 27 receives messages from a business server. For this reception, the business message reception processing unit 27 refers to an IP-address business server name management table 26 in order to recognize which of the business servers the message was transmitted from. The received messages are stored in databases 30-1 through 30-3 for each business server on the basis of the information in a DB management table 28. A DB request reception processing unit 29 receives a DB request for message transmission from the backup site, searches the databases 30-1 through 30-3 in order to extract the target message, and transmits the response message to the backup site.

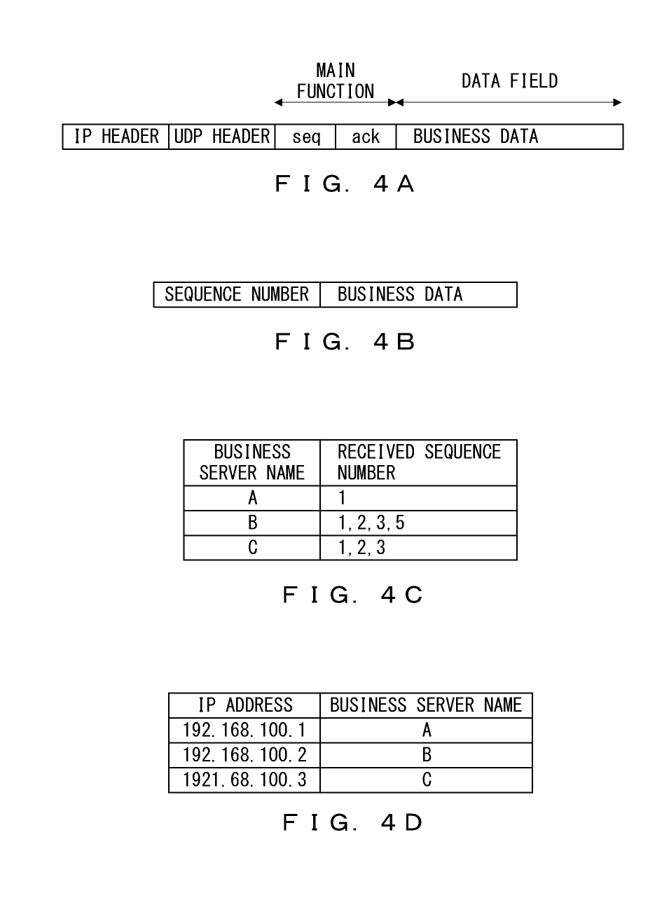

FIGS. 4A through 7C illustrate the respective data formats according to an embodiment of the invention.

FIG. 4A illustrates a format of a business message. A conventional set of headers including an IP header and a UDP header necessary for communications is added to the business data in the data part. In the present embodiment, the header part further includes the sequence number of the message and the Ack field. A sequence number by which messages can be identified uniquely for each business server can be checked, and by checking this number, whether or not the received message is partially lost can be checked. An Ack is used by a database server to response to the business server, and the database server transmits, to the business server, a message having the Ack set to the sequence number of the received message. The business server checks the sequence number of ack, and when the number is identical to the sequence number of the message that the business server itself transmitted, the business server determines that the message was transmitted properly, and stores the sequence number of that message as the number of the transmitted message.

FIG. 4B illustrates a data format used when a message is stored in a database in the database server.

The sequence number included in the business message is added to business data to be stored. The sequence numbers are used as the key for searching for a business message.

FIG. 4C illustrates a data format of a backup server sequence number management table.

The backup server sequence number management table stores sequence numbers of received messages for each business server. In the example illustrated in FIG. 4C, the message with sequence number “1”, the messages with sequence numbers “1”, “2”, “3”, and “5”, and messages with sequence numbers “1”, “2”, and “3” are received respectively from business servers A, B, and C.

FIG. 4D illustrates a data format of the IP address-business server name management table. The IP addresses of respective business servers and the names of the business servers are associated with each other, and are stored.

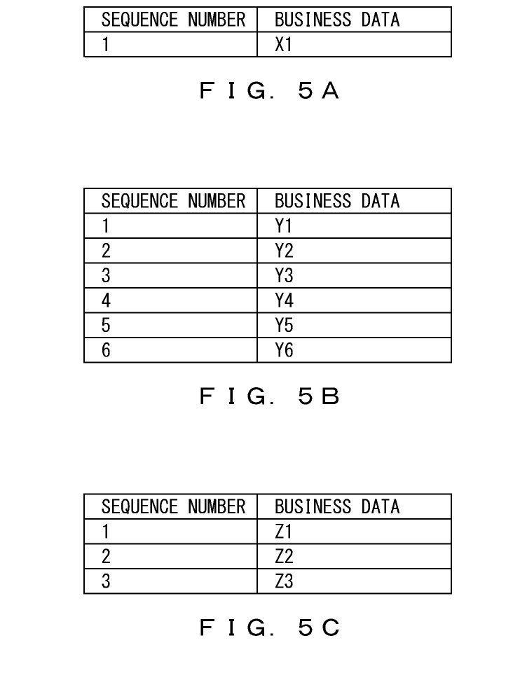

FIGS. 5A through 5C illustrate examples of the content of databases in database servers. FIG. 5A illustrates data received from business server A, FIG. 5B illustrates business data received from business data B, and FIG. 5C illustrates business data received from business server C. Pieces of business data received from respective business servers are stored for each of the business servers. FIG. 5A indicates that business data X1 with sequence number “1” was received from business server A. FIG. 5B indicates that pieces of business data Y1 through Y6 with sequence numbers “1” through “6” were received from business server B. FIG. 5C indicates that pieces of business data Z1 through Z3 with sequence numbers “1” through “3” were received from business server C.

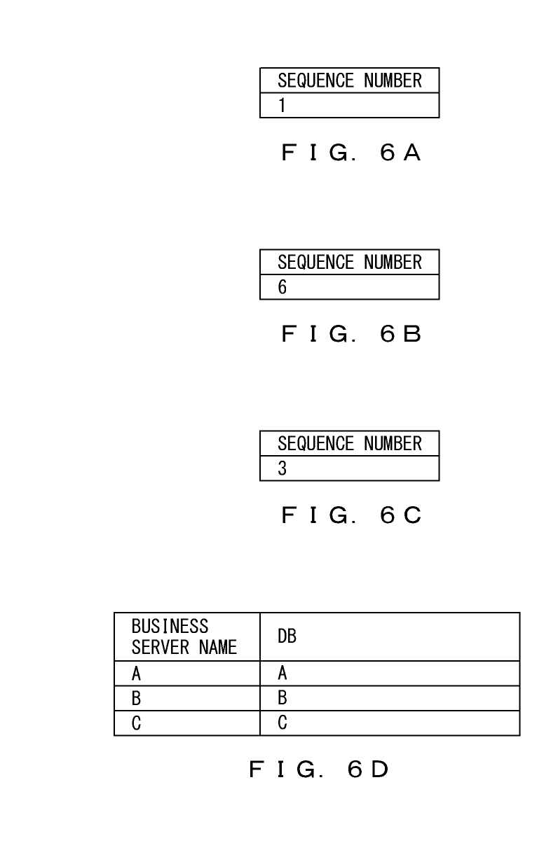

FIGS. 6A through 6C illustrate examples of the transmitted-message sequence number management table in a business server. FIG. 6A indicates that the business data with sequence number “1” is in an already-transmitted state in business server A. FIG. 6B indicates that messages with sequence numbers “6” and smaller are in an already-transmitted state in business server B. FIG. 6C indicates that messages with sequence numbers “3” and smaller are in an already-transmitted state in business server C.

FIG. 6D illustrates an example of the DB management table for storing the names of business servers that transmitted received messages and the names of databases storing the business data included in those messages in an associated state.

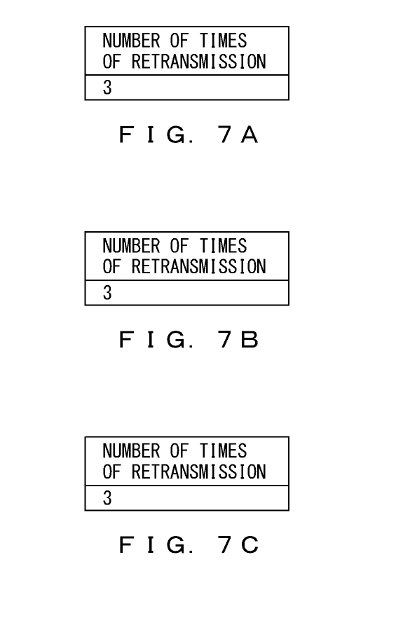

FIGS. 7A through 7C illustrate examples of the retransmission time management table. A retransmission time management table is provided in each business server. FIGS. 7A through 7C respectively illustrate examples of retransmission time management tables in business servers A through C. In these examples, the number of retransmissions is set to “3” in each of the tables.

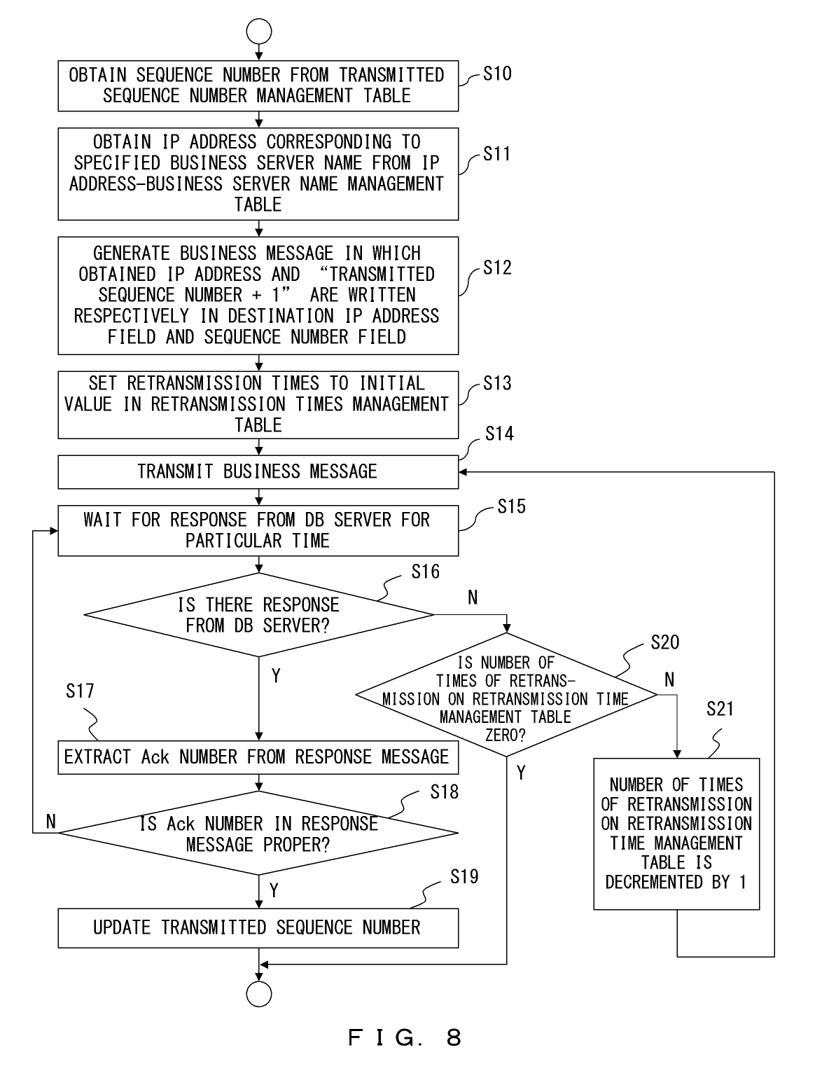

FIG. 8 illustrates a process flow in a business server used when it is transmitting a business message.

In step S10, a sequence number is obtained from the transmitted sequence number management table. Instep S11, the IP address corresponding to the specified business server name is obtained from the IP address-business server name management table. In step S12, a business message is generated according to the business message format (FIG. 4A), and the above obtained IP address and “the above obtained sequence number+1” are written respectively in the destination IP address field and the sequence number field. In step S13, the retransmission times are set to the initial value in the retransmission time management table. In step S14, the business message is transmitted to the database server. In step S15, the process waits for a response from the database server for a particular time. In step S16, it is determined whether or not a response was received from the database server. When it is determined that in step S16 that a response was not received, the process proceeds to step S20. When it is determined that a response was received, the Ack number in the received business message is checked in step S17, and it is determined whether the Ack number in the response message is a proper number in step S18. When the Ack number is proper (identical to the sequence number in the transmitted business message), the transmitted sequence number management table is updated according to the Ack number in step S19, and the process is terminated. When the Ack number is not proper, the process returns to step s15 where the process waits for a response from the database server.

When a response is not received from the database server, the retransmission time management table is checked to determine whether or not the number of times of retransmission is zero in step S20. When the number of times of retransmission is zero, it is determined that a time out has occurred, and the process is terminated. When the number of times of retransmission is not zero, that number is decremented by 1 in step S21, and is stored in the retransmission time management table, and thereafter the business message is retransmitted (step S14).

When receiving a business message from a business server, the backup server performs a business message reception process of storing the business data in a DB, and performs a DB data complement process of synchronizing the DB server and the data when the DB synchronization time expires.

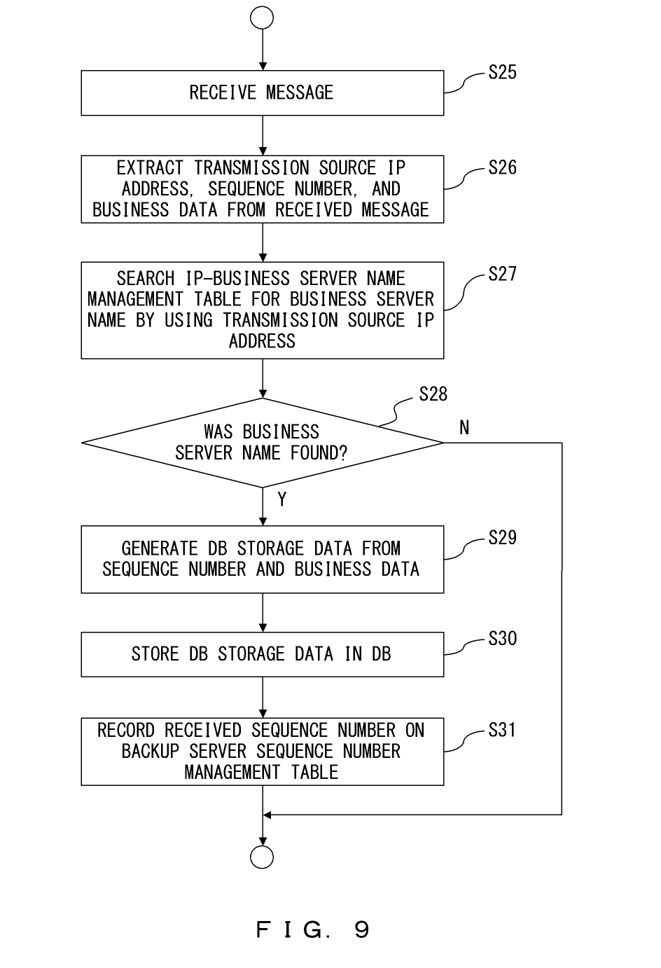

FIG. 9 illustrates a process flowchart for a business message reception process performed by the backup server.

In step S25, a business message is received from a business server. In step S26, the transmission source IP address, the sequence number, and the business data are extracted. In step S27, a search is made in the IP address-business server name management table to retrieve the business server name corresponding to the extracted transmission source IP address. In step S28, whether or not the business server name was found is determined. When the business server name was not found, the message is treated as an improper business message, and the process is terminated. When it is determined in step S28 that the business server name was found, database storage data is generated from the sequence number and the business data in step S29, and the generated database storage data is stored in a database (step S30). In step S31, the field of the corresponding business server name on the backup server sequence number management table is updated according to the stored sequence number.

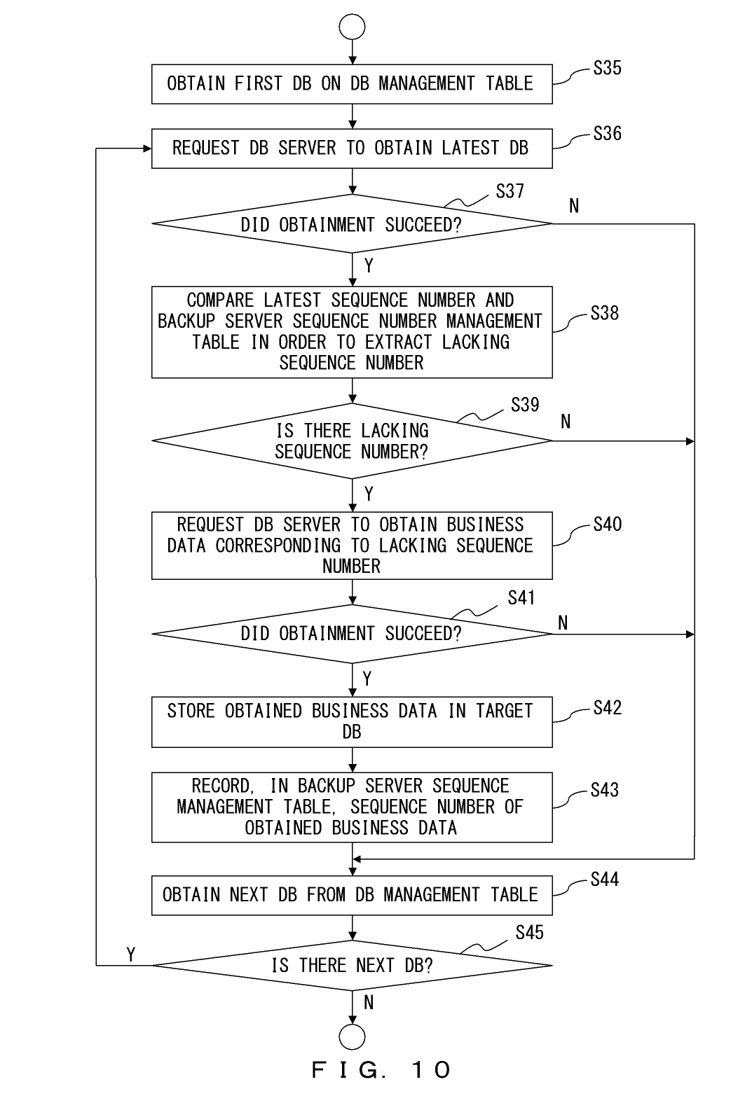

FIG. 10 illustrates a process flowchart for the DB data complement process performed by the backup server.

This process is repeated each time the DB synchronization time expires in the backup server. In step S35, the first database on the database management table is obtained. In step S36, a request for obtaining the latest database is made to the database server. In step S37, whether or not the obtainment of the latest database succeeded is determined. When it is determined that it failed, the process proceeds to step S44. When it is determined that the obtainment succeeded in step S37, the obtained latest sequence number is compared with the received sequence number of the corresponding business server on the backup server sequence number management table in step S38 in order to extract lacking sequence numbers, i.e., the sequence numbers that are equal to or smaller than the latest sequence number and that do not exist on the backup server sequence number management table. Instep S39, it is determined whether or not there is a lacking sequence number. When it is determined in step S39 that there is not a lacking sequence number, no more processing is considered necessary, and the process proceeds to step S44. When it is determined in step S39 that there is a lacking sequence number, a request for obtaining the business data corresponding to the lacking sequence number is made in step S40. In step S41, whether or not the obtainment succeeded is determined. When it is determined in step S41 that the obtainment succeeded, the obtained business data is stored in the database in step S42, and the sequence number of the obtained business data is recorded in the backup server sequence number management table in step S43.

In step S44, an attempt is made to obtain the next database name from the database management table, and whether or not there is a next database is determined. When the next database does not exist, the process is terminated. When the next database exists, a request for obtaining the latest database is again made to the database server in step S36.

The DB server performs a business message reception process of storing the business data in a DB when receiving a business message from a business server, and performs a DB request response process of giving a response according to the requested content, when receiving a request at the DB.

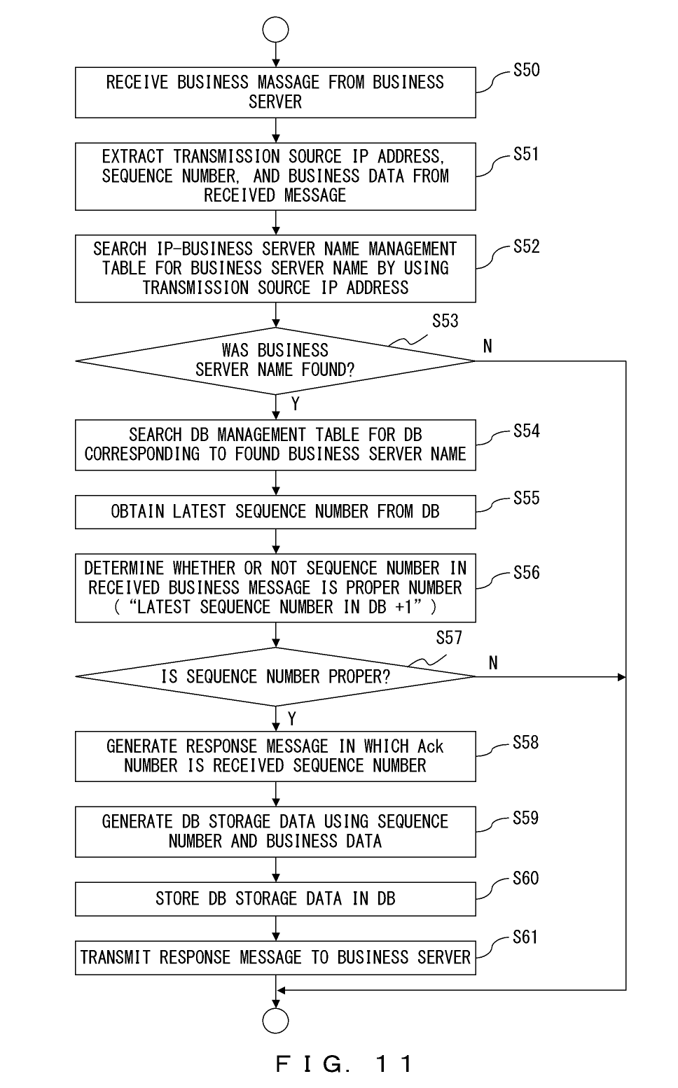

FIG. 11 illustrates a process flowchart for the business message reception process performed by the DB server.

In step S50, a business message is received from a business server. In step S51, the transmission source IP address, the sequence number, and the business data are extracted. In step S52, a search is made in the IP address-business server name management table to retrieve the business server name corresponding to the extracted transmission source IP address. In step S53, whether or not the business server name was found is determined. When the business server name was not found, the message is treated as an improper business message, and the process is terminated. When it is determined in step S54 that the business server name was found, a search is made in the database corresponding to the found business server name in the database management table in step S54, and the latest sequence number is obtained from the database in step S55. In step S56, it is determined whether or not the sequence number extracted from the received business message is a proper number (“the sequence number obtained from the database+1”), and when the number is determined in step S57 to be improper, the process is terminated. When the number is determined in step S57 to be proper, a response message is generated in which the destination address is the transmission source IP address in the received business message and the Ack number is the sequence number in the received message. In step S59, DB storage data is generated using the sequence number and the business data extracted from the received business message. In step S60, the data is stored in a database. In step S61, the response message is transmitted to the business server.

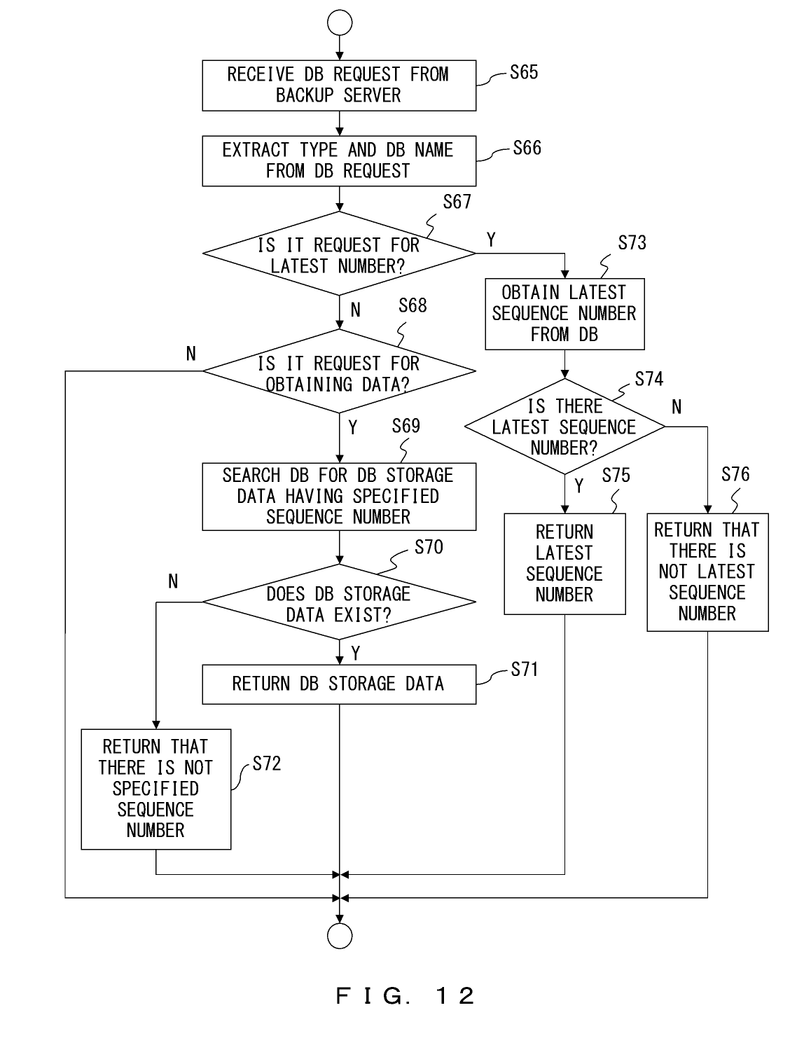

FIG. 12 illustrates a process flowchart for the DB request response process performed by the DB server.

In step S65, a DB request is received from the backup server, and the type of request and the name of the DB are obtained from the DB request. In step S67, whether or not the type of request is a request for the latest sequence number is determined. When it is determined in step S67 that the type of request is a request for the latest sequence number, the latest sequence number is obtained from the corresponding database, and whether or not there is a latest sequence number is determined in step S74. When the determination result in step S74 is Yes, the latest sequence number is returned in step S75, and the process is terminated. When the determination result is No in step S74, the fact that there is not a latest sequence number is returned to terminate the process in step S76. When the type is not of a request for the latest sequence number in step S67, it is determined in step S68 whether or not the type is of a request for obtaining data. When it is determined in step S68 that the type is not of a request for obtaining data, the process is terminated. When the type is of a request for obtaining data, a search is made in the database to retrieve the database storage data with the specified sequence number in step S69, and it is determined whether or not the database storage data actually exits in step s70. When the database storage data is found, that data is returned in step S71, and when the database storage data is not found, the fact that the specified sequence number was not found is returned in step S72.

Explanations of the content of communications (methods of requesting and responding) in the DB request response process will be omitted because such communications are based on the functions included in generally-used database server software.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A backup device in a system including a business server that generates a business message and transmits the business message to a database as main storage means for storing business data in the business message and to a backup database for storing the business data for backing up the business data, said device comprising:
a business data reception/extraction unit for receiving the transmitted message, and extracting the business data included in the message;
a business data storage unit for storing, in the backup database, the business data for each business server as a transmission source;
a lost business data detection unit for detecting whether or not the business data stored in the backup database is partially lost; and
a lost business data transmission requesting unit that does not request the business server, but requests the database to transmit lost business data when the business data is partially lost, wherein:
the business data is transmitted from the business server using multicast transmission.

2. The backup device according to claim 1, wherein:
a sequence number for uniquely identifying business data in the business message for each business server is added to the business message.

3. The backup device according to claim 2, wherein:
the database and the backup database store the business data and the sequence number in an associated state.

4. The backup device according to claim 3, wherein:
the lost business data detection unit detects loss in the business data by detecting loss in the sequence number.

5. The backup device according to claim 1, wherein:
the multicast transmission is a reliable multicast transmission.

6. The backup device according to claim 1, wherein:
the detection of loss in the business data and the request for transmission to be made to the database when there is loss are performed and made periodically at regular intervals.

7. A business server that includes, in a business message, business data generated by an execution of business, and that transmits the message to a database as a main storage unit for storing the business data in the business message and to a backup database for storing the business data so as to back up the business data, said server comprising:
a multicast unit for multicasting the business message to the database and the backup database.

8. A database device for controlling a database in a system including a business server that generates a business message and transmits the message to a database as a main storage unit for storing business data in the business message and to a backup database for storing the business data for backing up the business data, said device comprising:
a business data storage unit for receiving the business message from the business server, and storing the business data in a database;
a business data retransmission requesting unit for requesting the business server to retransmit the business data when the business data is partially lost;
a transmission request receiving unit for receiving a request for transmission of the lost business data from the backup database when the business data stored in the backup database is partially lost; and
a transmission unit for including, in a business message, the business data about which the transmission request was made, and transmitting the message to the backup database, wherein:
the business message is transmitted from the business server using multicast transmission.

9. The database device according to claim 8, wherein:
a sequence number for uniquely identifying the business data is added to the business message.

10. The database device according to claim 9, wherein:
the data retransmission requesting unit detects loss in the business data by detecting loss in the sequence number.
